(19) United States
(12) Patent Application Publication
(10) Pub. No.: US 2006/0158812 A1
(43) Pub. Date: Jul. 20, 2006

(54) Transient blocking unit having shunt for over-voltage protection

(76) Inventors: Richard A. Harris, Palo Alto, CA (US); Francois Hebert, San Mateo, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/331,836

(22) Filed: Jan. 12, 2006

Related U.S. Application Data
(60) Provisional application No. 60/644,478, filed on Jan. 14, 2005.
(60) Provisional application No. 60/693,693, filed on Jun. 24, 2005.
(60) Provisional application No. 60/735,667, filed on Nov. 10, 2005.

(51) Int. Cl. H02H 3/22

(52) U.S. Cl. 361/111

(57) ABSTRACT

A transient blocking unit (TBU) having improved damage resistance is provided. A TBU includes two or more depletion mode transistors arranged to provide a low series impedance in normal operation and a high series impedance when the input current exceeds a predetermined threshold. At least one of the TBU transistors is a protecting device having a shunt circuit element connected in parallel with its channel. When the TBU is in its high impedance state, the shunt circuit element provides a current path, thereby decreasing terminal voltages on at least one of the TBU transistors. The shunt element can be a discrete or integrated resistor, a current source including a transistor, or an appropriately engineered device parasitic.

### CROSS REFERENCE TO RELATED APPLICATIONS

This application claims the benefit of U.S. provisional application Nos. 60/644,478 filed on Jan. 14, 2005, 60/693,693 filed on Jun. 30, 2005, and 60/735,667 filed on Nov. 10, 2005, all of which are hereby incorporated by reference in their entirety.

### FIELD OF THE INVENTION

This invention relates to use of a transient blocking unit (TBU) to protect an electrical load from over-voltage and/or over-current conditions.

### BACKGROUND

Many circuits, networks, electrical devices and data handling systems are operated in configurations and environments where external factors can impair their performance, cause failure or even result in permanent damage. Among the most common of these factors are over-voltage and over-current. Protection against these factors is important and has been addressed in the prior art in various ways.

Fuses that employ thermal or magnetic elements are one common protection measure. In other cases, protection circuits are available. Some examples are described in U.S. Pat. Nos. 5,130,262; 5,625,519; 6,157,529; 6,828,842 and 6,898,060. Protection circuits are further specialized depending on conditions and application. For example, in the case of protecting batteries or rechargeable elements from overcharging and over-discharging one can refer to circuit solutions described in U.S. Pat. Nos. 5,789,900; 6,313,610; 6,331,763; 6,518,731; 6,914,416; 6,948,078; 6,958,591 and U.S. Published Application 2001/00210192. Still other protection circuits, e.g., ones associated with power converters for IC circuits and devices that need to control device parameters and electric parameters simultaneously also use these elements. Examples can be found in U.S. Pat. Nos. 5,929,665; 6,768,623; 6,855,988; 6,861,828.

When providing protection for very sensitive circuits, such as those encountered in telecommunications the performance parameters of the fuses and protection circuits are frequently insufficient. A prior art solution embodied by transient blocking units (TBUs) that satisfy a number of the constraints is considered in international publications PCT/AU94/00358; PCT/AU04/00117; PCT/AU03/00175; PCT/AU03/00848 as well as in U.S. Pat. Nos. 4,533,970; 5,742,463 and related literature cited in these references.

In a TBU, two or more transistors are arranged such that they normally provide a low series resistance. However, when an over-voltage or over-current transient is applied to the TBU, the transistors switch to a high impedance current blocking state, thereby protecting a load connected in series to the TBU. Variations and/or refinements of the basic TBU concept are considered in U.S. Pat. Nos. 3,916,220, 5,319,515, 5,625,519, 5,696,659, 5,729,418, 6,002,566, 6,118,641, 6,714,393, 6,865,063, and 6,970,337

When a TBU is in a current blocking state, it is possible in some cases (e.g., if device pinch-off characteristics are not well matched) for a terminal voltage at one or more of the TBU transistors to rise to a potentially damaging level. One solution to this problem is to employ TBU transistors which can handle such terminal voltages. For example, MOS transistors with thick gate oxides can be employed. However, this solution has drawbacks, since increasing the gate oxide thickness increases the channel resistance and decreases device transconductance. Furthermore, many IC foundries only provide thin gate oxides.

Accordingly, it would be an advance in the art to provide a TBU having improved voltage handling capability.

### SUMMARY

According to the invention, one or more of the TBU transistors is shunted in order to reduce transistor terminal voltages during transient blocking. More specifically, at least one of the TBU transistors is a protecting device having a shunt circuit element connected in parallel with its channel. When the TBU is in its high impedance state, the shunt circuit element provides a current path, thereby decreasing terminal voltages on at least one of the TBU transistors. The shunt element can be a discrete or integrated resistor, a current source including a transistor, or an appropriately engineered device parasitic.

A key operating principle of the invention is that the current leakage provided by the shunt element prevents the development of high voltages across one or more of the TBU transistors in the high impedance state. Such high voltages can occur in conventional TBUs if the distribution of input voltage between the TBU transistors is asymmetric (e.g., due to device mismatch).

The invention provides various advantages. One advantage of the invention is that TBU transistor gate voltages during transient blocking can be reduced to low levels comparable to device pinch-off voltages. Thus, low voltage transistors having a thin gate oxide can be used in TBUs according to the invention. Another advantage of the invention is that the controlled current leakage provided by the shunt element can facilitate automatic TBU resetting by providing a current discharge path (e.g., in cases where the input to the TBU is capacitive). A further advantage of the invention is that simple CMOS-type technologies, which do not feature isolation between the body(channel) region of N-MOS devices (referred to as “low-side NMOS” by some technologists), since they are on the same substrate, can be utilized for this type of TBU circuit. To achieve full isolation, a BiCMOS-style process with at least one epi layer and at least one buried layer and multiple deep diffusions for junction isolation, or trenches for isolation, would have to be used, which results in a higher wafer cost. The cost difference can be significant (1.5 to 2× depending on the technologies).

### BRIEF DESCRIPTION OF THE DRAWINGS

FIG. 1 shows a conventional bipolar transient blocking unit.

FIG. 2 shows a conventional unipolar transient blocking unit.

FIG. 3 shows a bipolar transient blocking unit according to a first embodiment of the invention.

FIG. 4 shows a bipolar transient blocking unit according to a second embodiment of the invention.

FIG. 5 shows a unipolar transient blocking unit according to a third embodiment of the invention.

FIGS. 6a-c show examples of shunt resistance elements suitable for use in embodiments of the invention.

FIG. 7 shows a fourth embodiment of the invention, where a shunt resistance is provided by a resistive parasitic device.

### DETAILED DESCRIPTION

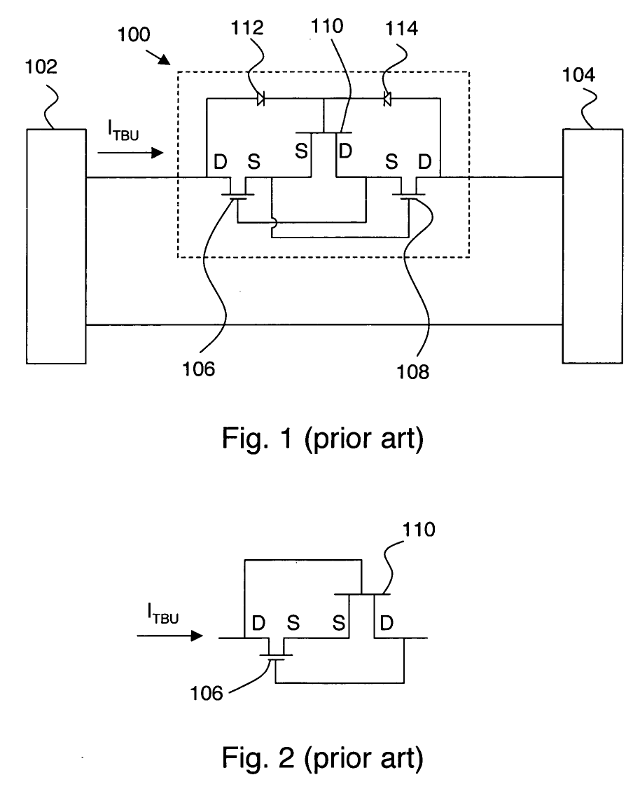

FIG. 1 shows a conventional bipolar transient blocking unit (TBU). In the arrangement of FIG. 1, a TBU 100 is disposed in series between an electrical source 102 and an electrical load 104. In ordinary operation, TBU 100 provides a low impedance and has a negligible effect on the operation of load 104 as driven by source 102. However, if a current through TBU 100 exceeds a predetermined value Iₒᵤₜ, the TBU rapidly switches to a high impedance state, effectively disconnecting load 104 from source 102. This rapid and automatic disconnection of load 104 from source 102 protects load 104 from over-current or over-voltage conditions that can occur in the output of source 102.

The basic principle of TBU operation is to pass the TBU current I_{TBU} through one or more normally on transistors (e.g., depletion mode transistors). The transistors are connected such that the voltage drops generated by the flow of I_{TBU} tend to turn off the transistors. As a result of this positive feedback, when I_{TBU} exceeds Iₒᵤₜ the TBU switches to a high impedance state, thereby protecting the load. The threshold current Iₒᵤₜ can be set to a predetermined value by appropriate design. There are various ways to connect the TBU transistors to provide this functionality. For example, FIGS. 1 and 2 show bipolar and unipolar TBU circuits respectively.

Conventional TBU operation is best appreciated by beginning with the unipolar example of FIG. 2. The circuit of FIG. 2 has a depletion mode n-channel NMOS transistor 106 (Q1) and a depletion mode p-channel JFET 110 (Q2). The source of Q1 is connected to the source of Q2, the gate of Q1 is connected to the drain of Q2, and the drain of Q1 is connected to the gate of Q2. The TBU input is the drain of Q1 and the TBU output is the drain of Q2. As I_{TBU} flows through Q1 and Q2, corresponding source-drain voltage drops V1 and V2 are generated. The gate to source voltage for Q2 is V1 and the gate to source voltage for Q1 is V2. As the gate to source voltages for Q1 and Q2 increase, V1 and V2 also tend to increase (since Q1 and Q2 are depletion mode devices), and this self-reinforcing feedback drives the TBU to a high impedance state when I_{TBU} exceeds the threshold Iₒᵤₜ.

The example of FIG. 2 is a unipolar TBU in the sense that it will act to block transients having a particular polarity (i.e., the polarity that tends to switch Q1 and Q2 off). Transients having the opposite polarity are not blocked by the circuit of FIG. 2. Bipolar protection can be provided by providing two TBUs as in FIG. 2 in series, one designed to block positive transients and the other designed to block negative transients. A more efficient alternative for bipolar protection is shown in the example of FIG. 1.

The circuit of FIG. 1 includes an n-channel depletion mode input NMOS transistor 106 (Q1), a p-channel JFET 110 (Q2) and an n-channel depletion mode output NMOS transistor 108 (Q3). The source of Q1 is connected to the source of Q2, the gate of Q1 is connected to the drain of Q2, the drain of Q1 is connected to the gate of Q2 via an input diode 112, the source of Q3 is connected to the drain of Q2, the gate of Q3 is connected to the source of Q2, and the drain of Q3 is connected to the gate of Q2 via an output diode 114. As I_{TBU} flows through Q1, Q2 and Q3, corresponding source-drain voltages V1, V2 and V3 are generated. Diodes 112 and 114 act to ensure that only one of Q1 and Q3 is coupled to the gate of Q2 (depending on the polarity of the transient being blocked). Thus for positive transients, Q1 and Q2 act together to block the transient (as in the circuit of FIG. 2), while for negative transients, Q2 and Q3 operate in this manner. Alternatively, the roles of Q1 and Q3 with respect to transient polarity can be exchanged.

When a TBU is in its high-impedance state (i.e., it is blocking a transient), I_{TBU} is not zero. Instead, a finite leakage current Iₗₑₐₖ flows through the TBU. The leakage current Iₗₑₐₖ is typically in a range from about a few μA to about 0.5 mA, depending on the TBU design. Since the same leakage current flows through all transistors of a TBU, mismatch of device characteristics can be problematic.

For example, suppose a TBU has an input NMOS transistor 106 which has a soft leakage characteristic compared to JFET 110. In this situation, the gate-source voltage V_{gs} of input transistor 106 will be significantly larger than V_{gs} of JFET 110 to provide the same leakage current Iₗₑₐₖ. High gate-source voltages can adversely affect device reliability (e.g., typically the maximum V_{gs} is restricted to ˜½ to ⅓ of the gate breakdown voltage). Thus a transistor having a 50 nm gate oxide thickness typically has a V_{gsmax} of about 15-20 V.

One possible solution is to employ transistors having a high voltage handling capability (e.g., having a thicker gate oxide). However, this solution has drawbacks, since increasing oxide thickness degrades device performance (e.g., increased channel resistance, reduced transconductance). Furthermore, thick gate oxide transistors are often not available from IC foundries.

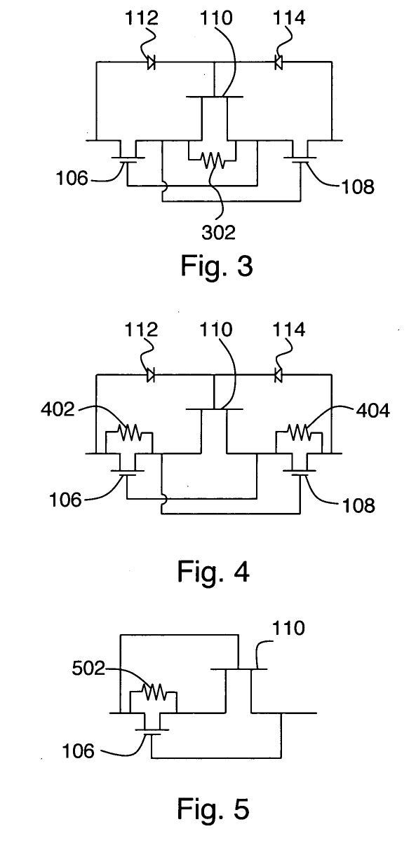

FIG. 3 shows an embodiment of the invention which addresses this problem. The TBU circuit of FIG. 3 is like that of FIG. 1 except for the addition of a resistor 302 connecting the source of JFET 110 to the drain of JFET 110. Thus resistor 302 is electrically in parallel with the channel of JFET 110. When the TBU of FIG. 3 is in its blocking state, the leakage current is determined primarily by the combination of NMOS transistor 106 and resistor 302. More specifically, Iₗₑₐₖ≈Vₚ/R, where Vₚ is the pinch-off voltage of transistor 106, and R is the resistance of resistor 302. For example, if R is 4 kΩ and Vₚ is 2V, the leakage current is 0.5 mA. From FIG. 3 it is apparent that V_{gs} of transistor 106 is the voltage across resistor 302, which is on the order of Vₚ. Since this voltage is typically low (e.g., ˜2V), thin gate oxide transistors can be employed. Thus the above-identified problem of excessive V_{gs} on transistor 106 is alleviated.

FIGS. 4 and 5 show further examples of embodiments of the invention. FIG. 4 shows a bipolar TBU where input transistor 106 is shunted by a resistor 402 and output transistor 108 is shunted by a resistor 404. This arrangement serves to protect JFET 110 from excessive gate voltages during transient blocking. FIG. 5 shows a unipolar TBU where NMOS transistor 106 is shunted by a resistor 502 to protect JFET 110 from excess gate voltages during transient blocking.

In more general terms, the invention relates to a TBU having at least one n-channel depletion mode device and at least one p-channel depletion mode device. These depletion mode devices are connected (e.g., as in the unipolar and bipolar examples above) such that an applied electrical transient that exceeds a threshold value alters the bias voltages of the devices so as to turn the devices off. In accordance with the invention, one or more of the depletion mode devices are protected devices and one or more of the depletion mode devices are protecting devices. Each protecting device has a shunt circuit element electrically connected in parallel with its channel. These shunt elements have parameters (e.g., resistances) selected such that terminal voltages (e.g., gate-source voltages) of the protected devices remain below a specified value when the TBU is blocking a transient.

Thus in the example of FIG. 3, JFET 110 is a protecting device and transistors 106 and 108 are protected devices. In the example of FIG. 4, transistors 106 and 108 are protecting devices and JFET 110 is a protected device. In the example of FIG. 5, transistor 106 is a protecting device and transistor 110 is a protected device.

A key idea of the invention is that this shunting decouples the TBU transistors from each other in the sense that transistor terminal voltages when the TBU is blocking are independent of how the device pinch-off characteristics match up, in sharp contrast to the situation with a conventional TBU. To further appreciate the invention, it is noteworthy that in the particular case of TBU design, a “leaky” transistor having a non-negligible shunt element in parallel with its channel is useful. This is in sharp contrast to most transistor applications, where such shunt elements are highly undesirable. Design of general purpose transistors routinely includes minimization of such shunt device parasitics.

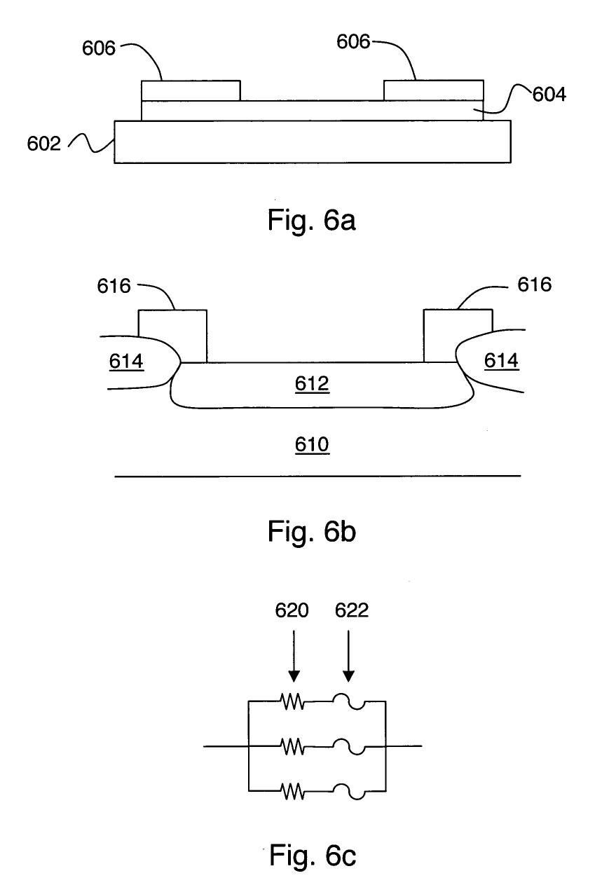

Shunt circuit elements suitable for practicing the invention include discrete thin film resistors, discrete diffused resistors, resistors integrated with the channel of a protecting device, programmable arrays of resistors, and current sources including transistors. FIG. 6a shows a thin film resistor having contacts 606 disposed on a resistive layer 604 disposed on a substrate 602. FIG. 6b shows a diffused resistor having contacts 616 connected to a resistive region 612 of opposite conductivity type from a substrate region 610 where a field oxide 614 define the boundaries of the resistor. FIG. 6c shows a programmable array of resistors 620 and connection elements 620. The total resistance provided by the array of FIG. 6c can be altered by selectively opening and closing some of connection elements 620. For example, connection elements 620 can be lithographically defined features (i.e., programming the resistance is done during fabrication by selection of a mask pattern). Alternatively, or in addition, connection elements 620 can be fuses which are selectively blown in a post-fabrication trimming process step to adjust the resistance value.

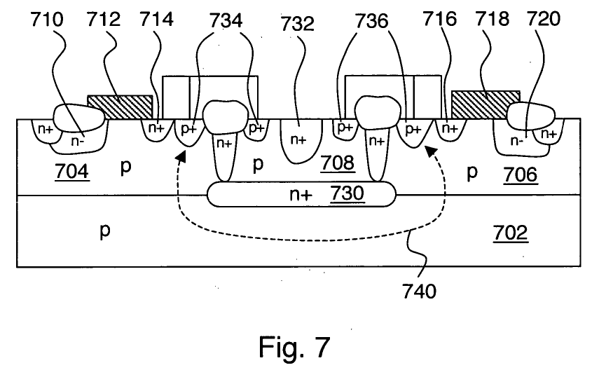

The shunt circuit element can also be a device parasitic designed to provide an appropriate resistance, as shown on FIG. 7. In this example, an input NMOS transistor Q1 has a source 714, a gate terminal 712 and a drain 710 and an output NMOS transistor Q3 has a source 716, a gate terminal 718 and a drain 720. Transistors Q1 and Q3 are disposed in p-wells 704 and 706 respectively. A p-channel JFET Q2 has a source 734, a gate 732 (including back gate 730), a drain 736 and a p-channel 708. This integrated circuit is disposed on a p-doped substrate 702. Source 714 of Q1 and source 734 of Q2 are electrically connected and source 716 of Q3 and drain 736 of Q2 are electrically connected. Thus the device-level diagram of FIG. 7 shows some of the devices and connections of the TBU schematic of FIG. 3. A parasitic current path 740 connects source 734 of Q2 to drain 736 of Q2. Since this parasitic current path is electrically in parallel with the channel of Q2, it provides a suitable shunt circuit element for practicing the invention.

The resistance provided by this device parasitic will depend on device layout, spacing and dimensions, the resistivity of substrate 702, and (to second order) on the resistivity of the device epitaxial layers. These parameters can be tailored to provide a desired level of shunt resistance. Advantages of this embodiment include fewer components leading to reduced die size and cost, low current density, and the ability to alter the resistance by selecting substrate resistivity. Typical p-substrate resistivities are in the range from 5-20 Ωcm, but a much wider range of resistivity (i.e., about 10⁻³ Ωcm to about 10³ Ωcm) is commercially available. Preferably the substrate resistivity is about 100-200 Ωcm, which is suitable for obtaining ˜5 kΩ shunt resistance in a TBU having a die size of about 1 mm×2 mm.

The preceding description of the invention is by way of example as opposed to limitation. Thus the invention can be practiced according to many variations of the above embodiments. For example, voltage protected TBUs can make use of any kind of depletion mode transistor, such as N or P channel MOSFETs, N or P channel JFETs, static induction transistors, or any other kind of field effect transistor. Although NMOS input and output transistors in combination with a p-channel JFET is preferred, any combination of transistor types is suitable for practicing the invention.

The preceding description refers to various field effect transistors having a source, gate and drain for specificity. It is well known in the art that many field effect transistors are symmetric with respect to their source and drain, in the sense that these connections can be exchanged without substantially altering device or circuit operation. Such transistors often have their source and drain terminals designated with “D/S”. For the bipolar TBU embodiment of FIG. 3, it is preferred for JFET 110 to be a symmetric FET (although NMOS transistors 106 and 108 are typically not symmetric). The source and drain terminals in the preceding examples can be exchanged in cases where symmetric transistors are employed. In view of this possibility, the preceding examples giving specific source and drain connections are to be understood as also being examples of connections to first and second FET channel terminals, where the first and second channel terminals can be source and drain respectively, or can be drain and source respectively.

1. An apparatus for electrical transient blocking comprising:
a transient blocking unit including at least one n-channel depletion mode device and at least one p-channel depletion mode device, wherein the depletion mode devices are connected such that an applied electrical transient alters a bias voltage Vₚ of said depletion mode p-channel device and alters a bias voltage Vₙ of said depletion mode n-channel device to block the transient by switching off the depletion mode devices;
wherein one or more of the depletion mode devices are over-voltage protected devices;
wherein one or more of the depletion mode devices are over-voltage protecting devices;
wherein each of the protecting devices has a channel and includes a shunt circuit element electrically connected in parallel with its channel;
wherein the shunt circuit elements have one or more predetermined parameters selected to ensure that terminal voltages of the protected devices remain below a specified value when the transient blocking unit is blocking the transient.

2. The apparatus of claim 1, wherein said shunt circuit element comprises an element selected from the group consisting of discrete thin film resistors, discrete diffused resistors, resistors integrated with said channel of said protecting device, programmable arrays of resistors, and current sources including transistors.

3. The apparatus of claim 1, wherein said shunt circuit element comprises a resistive parasitic device having a current path passing through part of a substrate of said protecting device.

4. The apparatus of claim 3, wherein a resistance of said parasitic device depends in part on a resistivity of said substrate.

5. The apparatus of claim 1, wherein said transient blocking unit is a unipolar transient blocking unit.

6. The apparatus of claim 5, wherein said transient blocking unit comprises an input n-channel depletion mode NMOS transistor (Q1) and a p-channel depletion mode JFET (Q2), wherein Q1 and Q2 each have a first channel terminal, a gate and a second channel terminal, and wherein the first channel terminal of Q1 is connected to the first channel terminal of Q2, the gate of Q1 is connected to the second channel terminal of Q2, and the second channel terminal of Q1 is connected to the gate of Q2.

7. The apparatus of claim 6, wherein said protected devices include Q1 and said protecting devices include Q2.

8. The apparatus of claim 6, wherein said protected devices include Q2 and said protecting devices include Q1.

9. The apparatus of claim 1 wherein said transient blocking unit is a bipolar transient blocking unit.

10. The apparatus of claim 9, wherein said transient blocking unit comprises an input n-channel depletion mode NMOS transistor (Q1), a p-channel depletion mode JFET (Q2), and an output n-channel depletion mode NMOS transistor (Q3), wherein Q1, Q2 and Q3 each have a first channel terminal, a gate and a second channel terminal, and wherein the first channel terminal of Q1 is connected to the first channel terminal of Q2, the gate of Q1 is connected to the second channel terminal of Q2, the second channel terminal of Q1 is connected to the gate of Q2 via an input diode, the first channel terminal of Q3 is connected to the second channel terminal of Q2, the gate of Q3 is connected to the first channel terminal of Q2, and the second channel terminal of Q3 is connected to the gate of Q2 via an output diode.

11. The apparatus of claim 10, wherein said protected devices include Q1 and Q3 and said protecting devices include Q2.

12. The apparatus of claim 10, wherein said protected devices include Q2 and said protecting devices include Q1 and Q3.

13. A method for electrical transient blocking comprising:
providing a transient blocking unit including at least one n-channel depletion mode device and at least one p-channel depletion mode device, wherein the depletion mode devices are connected such that an applied electrical transient alters a bias voltage Vₚ of said depletion mode p-channel device and alters a bias voltage Vₙ of said depletion mode n-channel device to block the transient by switching off the depletion mode devices;
selecting one or more of the depletion mode devices to be over-voltage protected devices;
selecting one or more of the depletion mode devices to be over-voltage protecting devices;
providing a shunt circuit element corresponding to each of the protecting devices, wherein each of the protecting devices has a channel electrically connected in parallel with its corresponding shunt circuit element;
wherein the shunt circuit elements have one or more predetermined parameters selected to ensure that terminal voltages of the protected devices remain below a specified value when the transient blocking unit is blocking the transient.
